(19) United States
(12) Patent Application Publication
(10) Pub. No.: US 2017/0356836 A1
(43) Pub. Date: Dec. 14, 2017

(54) Method and Apparatus for Decreasing Tubing Carryover With Poly(2-hydroxyethyl methacrylate) Coating

(71) Applicant: Intellicyt, Albuquerque, NM (US)

(72) Inventor: Zhaoping Liu, Albuquerque, NM (US)

(21) Appl. No.: 15/621,500

(22) Filed: Jun. 13, 2017

Related U.S. Application Data
(60) Provisional application No. 62/349,943, filed on Jun. 14, 2016.

(51) Int. Cl. G01N 15/14; G01N 35/10; G01N 35/08; G01N 15/00

(52) U.S. Cl. CPC G01N 15/1404; G01N 15/1484; G01N 35/08; G01N 35/1095; G01N 2015/03

(57) ABSTRACT

A method for collecting and delivering biological samples to a destination, such as an analyzer are provided herein. In one example, a plurality of samples, each including particles, is obtained from respective wells of a sample source having a plurality of wells. The plurality of samples are introduced into a fluid flow stream contained within a conduit having an inner diameter and in communication with a destination. An inner surface of the conduit is coated with a hydrogel barrier substance, such as poly-HEMA. The fluid flow stream is guided through the conduit to a destination. In one example, the destination may be a flow cytometer. Methods of preparing a poly-HEMA solution and coating the inner surface of a conduit with poly-HEMA are also provided.

### RELATED APPLICATIONS

This application claims the benefit of priority to U.S. Provisional Application No. 62/349,943 entitled “Method and Apparatus for Decreasing Tubing Carryover With Poly(2-hydroxyethyl methacrylate) Coating,” filed on Jun. 14, 2016, the contents of which are hereby incorporated by reference in their entirety.

### BACKGROUND

Traditionally, flow cytometry has been used for low throughput sample analysis by placing samples, one-by-one, under the sip of the cytometer. Recently, high-throughput flow cytometry systems have been developed to quickly deliver samples at microliter volumes to the flow cytometry engine. In some systems, a peristaltic pump with microtubing and sample probe is used to drive the samples from a microtiter plate to the flow cytometer. Air gaps may be introduced into the tubing to separate neighbouring samples. While these high-throughput systems allow for the rapid evaluation of many samples in a short time, carryover from one sample to the next can occur. This may be due to the contents of biological samples, such as cells, adhering to the wall of tubing. While the extent of carryover can vary based on biological sample type and the length of the tubing, the carryover percentage between two neighbouring samples may, for example range between about 1-2%. Carryover between samples may affect the data integrity. Even when a cleaning solution is aspirated into the tubing in between samples, carryover may not be adequately limited.

### SUMMARY

Methods and systems for delivering biological samples from a sample source to a destination using poly-HEMA coated tubing, and methods of preparation of such coated tubing are disclosed herein.

Some embodiments of the present disclosure provide a method for sample delivery, comprising: (a) obtaining a plurality of samples from a sample source having a plurality of wells, wherein each sample of the plurality of samples is obtained from a respective well of the plurality of wells; (b) moving the plurality of samples comprising particles into a fluid flow stream contained within a conduit having an inner diameter and in communication with a destination, wherein an inner surface of the conduit is coated with a hydrogel barrier substance; and (c) guiding the fluid flow stream through the conduit to the destination.

Embodiments of the present disclosure further include a flow cytometry apparatus comprising: (a) an autosampler comprising a probe suitable for inserting a plurality of samples comprising particles from a plurality of respective source wells into a fluid flow stream; (b) a conduit having an inner diameter of between about 0.1 and 10 mm and connected to the probe of the autosampler and containing the fluid flow stream, wherein an inner surface of the conduit is coated with a hydrogel barrier substance; and (c) a flow cytometer in communication with the probe of the autosampler via the conduit, the flow cytometer configured to focus the fluid flow stream delivered by the conduit.

Further embodiments of the present disclosure include a method comprising: (a) preparing a Poly(2-hydroxyethyl methacrylate) (“poly-HEMA”) solution; (b) filling a conduit with the poly-HEMA solution; (c) incubating the conduit filled with the poly-HEMA solution at room temperature for an incubation period; and (d) after completion of the incubation period, priming the conduit with a buffer for a priming period. The step of preparing the poly-HEMA solution of an anti-adhesion substance comprises: (1) adding an amount of poly-HEMA powder in about 50-100% ethanol to achieve about a 5-100 mg/ml poly-HEMA solution; (2) warming the poly-HEMA solution to about 20-80° C.; (3) agitating the poly-HEMA solution every hour for at least two hours; (4) incubating the poly-HEMA solution at about 20-80° C. for about 8-16 hours; and (5) agitating the poly-HEMA solution until no poly-HEMA particles are visible in the solution.

Embodiments of the present disclosure further include a non-transitory computer readable medium having stored therein instructions that are executable to cause a processor to perform the methods described herein.

### BRIEF DESCRIPTION OF THE DRAWINGS

FIG. 1 illustrates an example conduit with a hydrogel barrier substance coating an inner surface thereof.

FIG. 2 illustrates the chemical structure of poly-HEMA.

FIG. 3 is a schematic system including a sample source and a destination connected by a conduit coated with a hydrogel barrier substance.

FIG. 4 is a schematic view of a high throughput flow cytometry apparatus.

FIG. 5A illustrates a heat map of cell acquisition numbers in each well of a 96-well plate obtained in an experiment using poly-HEMA coated microtubing.

FIG. 5B is a graphical representation of the carryover comparison between poly-HEMA coated tubing and uncoated tubing.

### DETAILED DESCRIPTION

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively.

The description of embodiments of the disclosure/examples is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

All embodiments of any aspect of the invention can be used in combination, unless the context clearly dictates otherwise.

For the purposes of the present invention, the term “particles” as used herein refers to small objects with physical size between lnm and 1 mm including, but not limited to, molecules, cells, proteins, protein aggregates, microbes, virus, microspheres, microbeads, cellular components such as nuclei, mitochondrion, chemical compounds, and chemical aggregates, etc.

For the purposes of the present invention, the term “sample” refers to a fluid solution or suspension containing particles.

For the purposes of the present invention, the term “well” as used herein may include any vessel for containing a sample, such as a chamber, dish, tube, bottle, vial, reservoir trough, or a well on a microtiter plate.

For the purposes of the present invention, the term “about” means+/−5% of the recited parameter.

For the purposes of the present invention, the term “analyzer” as used herein may include a flow cytometer, a high throughput flow cytometer (HTFC), an autoanalyzer, analytic equipment such as High Performance Liquid Chromatography (“HPLC”), or any mechanism capable of analyzing one or more samples in a fluid flow stream.

For the purposes of the present invention, the term “destination” as used herein includes any location, reservoir, or device, etc., that receives, moves, carries or otherwise handles a fluid, such as samples in suspension, via a tubing material, for a variety of applications such as medicine, testing and research, agriculture, food manufacturing, chemical handling, engineering and manufacturing, and water and waste, such as an analyzer, media dispenser, dialysis machine, media infusion pump, peristaltic pump, etc.

Methods and systems for transporting samples from a sample source to a destination, such as a flow cytometer, using tubing coated with a hydrogel barrier substance are described herein. In some examples, the hydrogel barrier substance is poly-HEMA, or one of its chemical derivatives. Methods for the coating of tubing with the hydrogel barrier substance are also disclosed.

Poly(2-hydroxyethyl methacrylate), also named poly-HEMA, is a water-swellable polymer and hydrogel. In the present application, poly-HEMA is used to coat the inner surfaces of the micro-tubing for the delivery of biological samples from the microtiter plate to the flow cytometer for analysis. Coating of the microtubing with poly-HEMA is shown in the examples that follow to drastically reduce carryover from the preceding sample to the following sample when used for sample delivery. In so doing, the efficiency of sample delivery to the flow cytometer and data integrity are improved by reducing sample contamination between neighboring samples. While the use in flow-cytometry systems is exemplified, the use of poly-HEMA coating will be beneficial in other sample analyzers or devices that use tubing to deliver more than one sample.

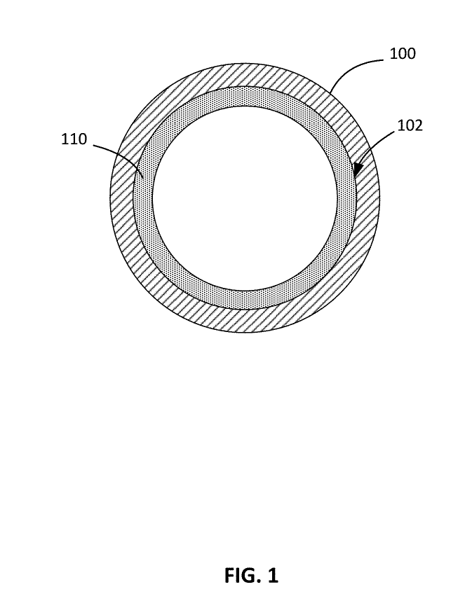

In one embodiment of the present invention, a hydrogel barrier substance, such as poly-HEMA, is used to coat the inner surface of a conduit. FIG. 1 illustrates an example conduit 100 with a layer of a hydrogel barrier substance 110 deposited on an inner surface 102 thereof. The conduit 100 may include any pathway through which samples are transported between a sample source and a destination. Depending on the application, the volume and contents of the samples, the type of destination, etc., the inner diameter of the conduit may vary. For example, peristaltic pump tubing is available in a variety of sizes for different applications. For a flow cytometry application, the inside diameter of the conduit may range between about 0.1 and about 10 mm. More particularly, the inner diameter of the conduit may be about 0.25 mm. Similarly, the material of the conduit may be selected based on the application. In some examples, the conduit may be made of plastic, such as polyvinyl chloride (PVC), silicone, polypropylene, or natural rubber. For flow cytometry applications, the tubing is typically made of plastic. In other applications, the conduit can be made of a metal, such as aluminium or steel, fiberglass, or a composite material. Further, any thickness of the hydrogel barrier substance coating the inner surface of the conduit, so long as there is at least one layer of the substance, will provide the desired benefits. Greater thicknesses of the hydrogel barrier may provide additional benefit, so long as the thickness does not occlude flow in the conduit. For example, in some embodiments, the thickness of the hydrogel barrier is no more than 20% of the inner diameter of the conduit. The thickness of the hydrogel barrier may range, in some examples, from about 5 μm to about 100 μm.

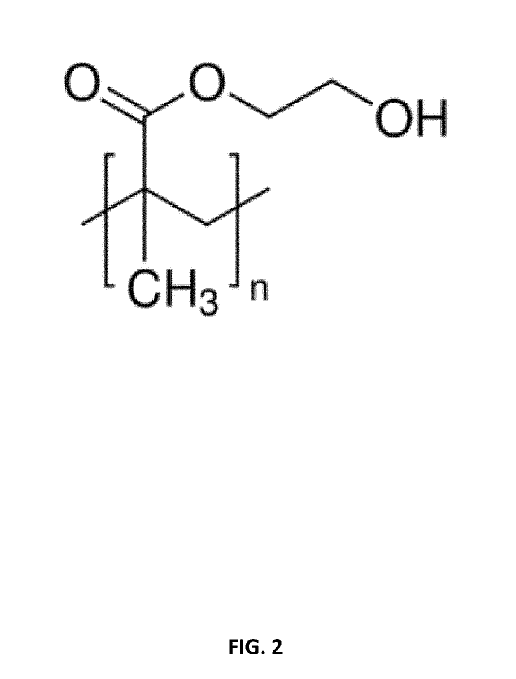

The hydrogel barrier substance may comprise or consist of poly-HEMA, or one of its chemical derivatives such as polydimethylsiloxane, polymethyl methacrylate, polystyrene, or a polyethylene glycol diacrylate-based hydrogel. Poly-HEMA, with full name poly(2-hydroxyethyl methacrylate), is a water-swellable polymer and hydrogel. The chemical structure is shown in FIG. 2. The CAS number is 25249-16-5. The linear formula: (C6H10O3)n. The MDL number is: MFCD00084374. The PubChem Substance ID: 24898472. The expected molecular weight range is between 20,000 and 1,000,000. In this application, a cross-linker may not be required to form the poly-HEMA coating, though one can be used as appropriate for a specific use. While pure poly-HEMA (or one of its chemical derivatives) is described herein, other components may be incorporated into the hydrogel. In some examples, the hydrogel barrier substance is biologically inert. Poly-HEMA may, in one aspect, limit adhesion of biological components of a sample by reducing the negative electrostatic charge of the interior surface of the conduit. In another aspect, a coating of poly-HEMA may act to smooth out any protrusions or spicules on the interior surface of the conduit that may otherwise act as available contacts points to which the biological components may adhere.

Other substances for limiting adhesion of sample components on the inside of the conduit, such as Tween 20, pluronic F68, sodium hypochlorite, citric acid, and bovine serum albumin (BSA) were compared to poly-HEMA. Tween is a surfactant that acts to break surface tension. BSA acts as a buffer between the carried components and the conduit material. However, the poly-HEMA coating unexpectedly provided a significantly better adhesion barrier than these other substances.

The hydrogel barrier substance coating described above may be used in any application requiring a conduit (such as tubing) to transfer more than one sample from a source to a destination, and which may be subject to sample carryover issues. It is contemplated that a hydrogel barrier coated conduit may be provided on its own, for use in whatever application a user desires, or as an integral part of a system. For example, the hydrogel barrier substance coated tubing could be integrated into high throughput flow cytometry systems, including but not limited to the Intellicyt Corproration iQue® Screener and iQue® Screener Plus systems, HTFC®, or other flow cytometry systems that utilize tubing to deliver more than 1 biological sample.

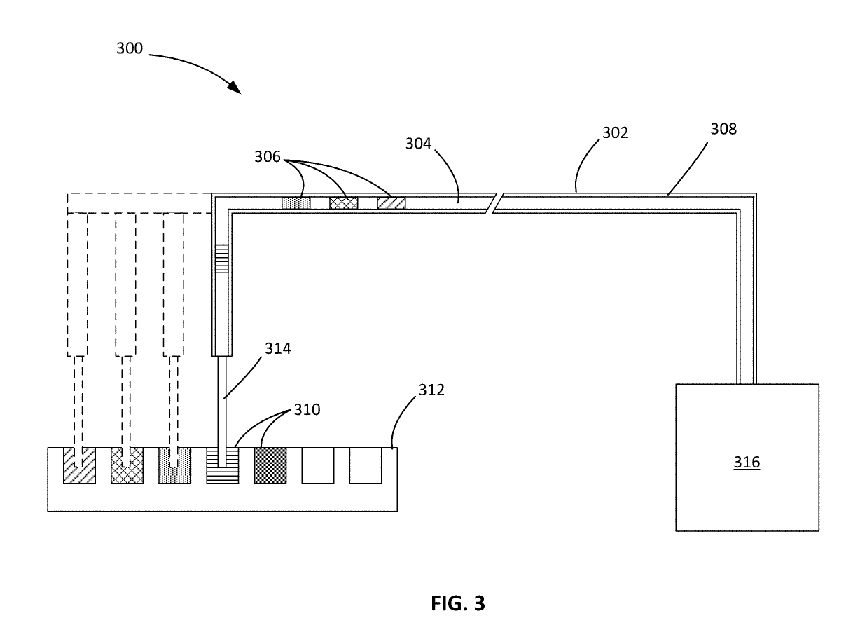

FIG. 3 provides a schematic illustration of a system 300 including a conduit 302 defining a fluid flow stream through which a plurality of samples comprising particles are moved. The inner surface of the conduit 302 is coated with a layer of a hydrogel barrier substance 308, such as poly-HEMA, which may have any of the characteristics of the hydrogel barrier substances described above. Each of the plurality of samples 306 is obtained from respective wells of a plurality of wells 310 of a sample source 312. In one example, the samples 306 are introduced into the fluid flow stream via a probe 314, which may be configured to move from sample well to sample well, collecting successive samples. This concept is schematically illustrated in FIG. 3 with the broken lines. The plurality of samples 306 in the flow stream 304 are guided through the conduit 302 to a destination 316, such as an analyser.

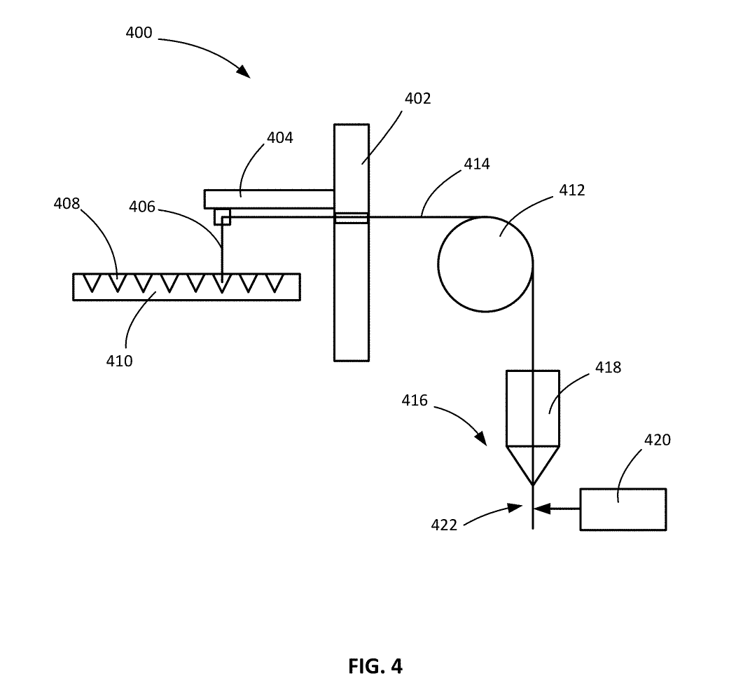

In another example, poly-HEMA is used to coat the inner surface of micro-tubing used for a high-throughput flow cytometry system for cell sample delivery. In operation, the use of hydrogel barrier substance-coated tubing drastically reduced cell carryover between two neighboring samples. FIG. 4 illustrates an exemplary flow cytometry apparatus 400 of the present invention. Flow cytometry apparatus 400 includes a conventional autosampler 402 having an adjustable arm 404 on which is mounted a hollow probe 406. As arm 404 moves back and forth (left and right in FIG. 4) and side to side (into and out of the plane of FIG. 4), probe 406 is lowered into individual source wells 408 of a well plate 410 to obtain a sample comprising particles (which may be tagged with a fluorescent tag (not shown in FIG. 4)) to be analyzed using flow cytometry apparatus 400. Once a sample is picked up by probe 406, it is introduced into a fluid flow stream and a peristaltic pump 412 forces the sample through a conduit 414 that extends from autosampler 402 through peristaltic pump 412 and into a flow cytometer 416 including a flow cell 418 and a laser interrogation device 420. The conduit 414 may have an inner diameter of between about 0.1 and 10 mm. The flow cell, which may have an inner diameter of about 100-500 μm, may be continuously operated to focus the fluid flow stream and to analyze the particles in each of the plurality of samples as the fluid flow stream passes through the flow cytometer. Laser interrogation device 420 examines individual samples flowing from flow cell 418 at a laser interrogation point 422. In between in-taking sample material from each of source wells 408, probe 406 is allowed to intake air, thereby forming an air bubble between each adjacent sample. As such, adjacent samples of the plurality of samples may separated from each other in the fluid flow stream by a separation gas.

As described above with respect to apparatus 300, an inner surface of the conduit may be coated with a hydrogel barrier substance. Further, an inner surface of the flow cell may also be coated with a hydrogel barrier substance, thereby providing anti-adhesion benefits to the flow cell as well. Adhesion of biological material in the samples to an inner surface of the flow cell can also lead to carryover between samples. The flow cell may be so coated during the same process by which the conduit is coated.

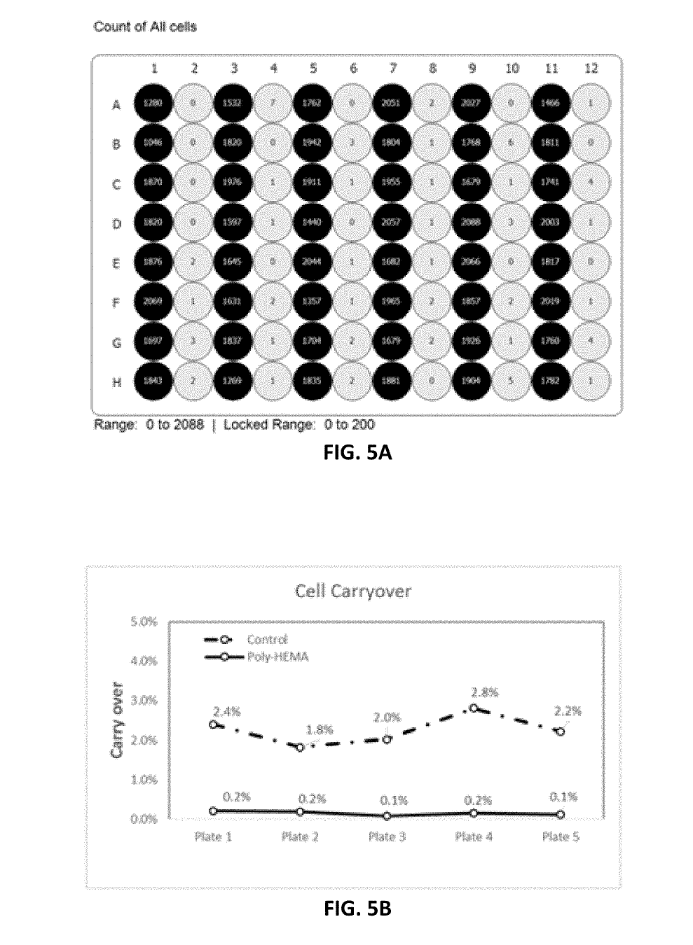

FIGS. 5A and 5B illustrate the results of experiments conducted to compare carryover during the delivery of cell samples for flow cytometry analysis between uncoated microtubing and microtubing coated with poly-HEMA. In sum, poly-HEMA drastically reduced tubing carryover. The pilot test results without any optimization showed great potential of this method in reducing the sample carryover.

In these experiments, poly-HEMA-coated micro-tubing was used to deliver Jurkat lymphocytic cell samples contained in a 96-well plate for analysis on an iQue screener from Intellicyt Corporation. The plate was set up by adding 30 uL/well 1 million cells/mL to the odd wells while the even wells had the cell media but no cells. Sampling progressed from left to the right for continuous 12-well sampling and then the plate was shaken for 4 seconds to resuspend cells in the plate before the sampling probe went to the next row and continued sampling from the left to the right for 12 wells. The sip time for each well to cell acquisition was 1 s. These sampling steps were repeated until the full plate was sampled. FIG. 5A is a heat map showing the cell number acquired from each well in a 96-well plate. The odd columns show the real cell number acquired, while the even column shows the artificial carryover cell number from the preceding well. FIG. 5B illustrates the carryover comparison between poly-HEMA coated tubing and the control uncoated tubing. The carryover rate was calculated by using the even well number to divide the odd well number. A single tube was used in each case for continuous test of 5 96-well plates. The carryover was the mean carryover of the plate (n=48).

The poly-HEMA coated tubing unexpectedly provided a marked decrease in sample carry over as compared to the uncoated tubing. In many applications, the microenvironment inside the tubing is very small (˜0.25 mm in diameter), with many dynamic factors affecting the flow of samples and their contents. It was, therefore, unexpected that the poly-HEMA coating would work to limit adhesion, particularly to the extent demonstrated in these examples.

Moreover, in some high-throughput flow cytometry systems, samples can be separated in the flow stream by air bubble gaps. Manipulation of the tubing in these systems can easily disrupt the air gaps, leading to difficulty in separating samples upon analysis. For example, while a surfactant may be used to decrease cell adhesion, surfactants can affect the air bubble formation by decreasing surface tension within the conduit. In evaluating the tubing coated with poly-HEMA, which does not drastically reduce surface tension, the integrity of the air gaps were not affected. Poly-HEMA, not like a surfactant, does not drastically reduce the surface tension.

Further, separating adjacent samples by air gaps in a conduit having a very small diameter, as is done in the example high-throughput flow cytometry system described herein, can increase sample carryover from one sample to the next, due to the combination of air dynamic turbulence, fluidic turbulence caused by the sample pump pushing the sample suspension through the microtubing, and general capillary effect. Traditional knowledge may suggest the use of a protein, such as bovine serum albumin, or a detergent, such as tween 20, to coat or clean the tubing to reduce carryover. However, in the above-described microenvironment with air-gap separated liquid samples and pressure introduced by a sampler pump in small diameter tubing, the use of proteins or detergents does not provide a significant reduction in adhesion. As shown by the examples and data presented herein, poly-HEMA, conversely, did demonstrate significant anti-adhesion properties in this microenvironment.

Table 1, below, illustrates preliminary data comparing the amount of cell carryover where the conduit was coated with poly-HEMA, versus other coatings such as Tween 20 and BSA. This data demonstrates that poly-HEMA provided marked improvement in cell carryover as compared to the other coating materials. As the poly-HEMA derivatives share a common chemical structure, it is expected that they will perform similarly as poly-HEMA to limit biological sample adherence to the inner surface of the tubing. In addition to the benefits of reduced carryover as illustrated in Table 1, literature suggests that poly-HEMA coating may be more stable and not as easily washed away as some of these other coatings, such as Tween 20 and pluronic F68.

TABLE 1

| | | 1% | | | | | | Phosphate |
|---|---|---|---|---|---|---|---|---|
| | 20 mg/mL | bovine | 1% | 0.5% | 1.5% | | 1% | Buffer |
| | poly- | serum | Tween | sodium | citric | 10% | Pluronic | Saline |
| | HEMA | albumin | 20 | hypochlorite | acid | sucrose | F68 | (PBS) |
| Cell | 0.1-0.2% | 1-2% | 1-2% | 1-2% | 1-2% | 2-3% | 0.5-1% | 1-3% |
| Carry-over | | | | | | | | |

Example methods for coating an inner surface of a conduit, such as microtubing, with a hydrogel barrier substance are also provided. While the following steps are described with reference to poly-HEMA, it is understood that other hydrogel barrier substances may be used in a similar fashion. In step one, a poly-HEMA solution is prepared. Poly-HEMA powder is weighed and added into about 50-100% ethanol to achieve about a 5-100 mg/ml poly-HEMA solution. As an alternative to ethanol, other organic chemical solvents, such as methanol and isopropanol, in equivalent concentrations may be used. In one example, 95% ethanol is added to reach 20 mg/mL. The solution is then warmed to about 20-80° C. In one example, the solution is warmed in a Falcon tube at 37° C. in a water bath. For the first 2-3 hours, the tube is agitated every hour, and then the solution is incubated at about 20-80° C. for about 8-16 hours. The tube is then agitated until no poly-HEMA particles are visible in the solution.

In step two, the desired microtubing is coated with poly-HEMA. While the following describes the use of a flow cytometry system, such as the Intellicyt Corporation iQue or iQue Screener Plus, it is understood that any other appropriate device capable of drawing the poly-HEMA solution into the desired conduit and performing the remaining steps may be used. The desired conduit, such as PVC tubing having an inner diameter of 0.25 mm, is filled with the poly-HEMA solution, prepared in step one set out above. This step may be carried out, for example, by installing new microtubing on a flow cytometry system. For example, the warm poly-HEMA solution is poured into a port where it can be drawn into the microtubing by the probe of a flow cytometry system. In one embodiment, the solution prepared in Step one can be poured into an empty cartridge in the Si rinse station on the Intellicyt Corporation iQue® Screener. The acquisition program using the sip time 59 s is initiated to draw poly-HEMA solution into the tubing.

In one example, the tubing is not cleaned prior to being coated. In another example, the tubing is prevented from contacting any chemical or solution prior to being coated.

Once the conduit is filled with the poly-HEMA solution, it is incubated at room temperature (for example) for an incubation period to allow the poly-HEMA to coat the inner surface of the conduit. In one example, the incubation period is about 2-20 minutes. In a further example, the incubation period is 5 minutes. After completion of the incubation period, the conduit is primed with a buffer, such as water, phosphate buffer saline (PBS), Hank's buffer saline solution (HBSS), culture media, or 0.1% bovine serum albumin in combination with PBS buffer, for a priming period to wash away the excess poly-HEMA that did not adhere to the conduit. In one example, the priming period is about 1-10 minutes. In further example, the priming period is about two minutes. Due to the enclosed geometry and small space of some conduits, a pumping mechanism is used to pump the poly-HEMA solution into the conduit, to pump the poly-HEMA solution out of the conduit after the incubation period, and to pump the buffer solution into the conduit to clean the inner surfaces. The buffer solution can be provided in a port where it can be drawn into the microtubing by the probe of a flow cytometry system. In one embodiment, the Intellicyt Corporation iQue® system can be used to prime the tubing by removing the poly-HEMA solution from the S1 rinse station referred to above, and replacing it with a port containing the priming solution, such as an S1 priming cartridge.

The above-described steps have been shown to acceptably coat the inner surface of a plastic-based conduit. Additional steps may be implemented for other conduit materials. For example, an additional heat-treatment step may be used in the case of metal conduits. In comparison, a flat surface or other structure in an open environment (e.g., plates, wells, dishes) can typically be coated by submerging the article in a solution of poly-HEMA and then allowing it to dry.

In examples where the conduit is a component of a flow cytometry device, the conduit is in fluid communication with the flow cytometer. The flow cytometer may also include a flow cell, having an internal diameter of about 100 μm to about 500 μm. After the incubation period, the introduction of the buffer into the conduit flushes the poly-HEMA solution (and buffer) into the flow cytometer and flow cell, which may cause the poly-HEMA to coat the inner surface of the flow cytometer and flow cell.

It is noted that, after priming/washing of the tubing, it is possible that some solvent molecules used in preparation of the poly-HEMA solution, such as ethanol, may be retained in the poly-HEMA coating on the tubing. Also, in some systems where the poly-HEMA and wash buffer pass through the flow cytometer, it is possible that some poly-HEMA and solvent molecules may be retained on the inner wall of the flow cell of the flow cytometer. In addition, it is possible, that some poly-HEMA and solvent molecules may be retained on the inner wall of the sample probe, or other mechanism, that is used to draw the liquid into the tubing during the coating and following rinse steps. The trace amounts of poly-HEMA retained on the internal surfaces of the sample probe and the flow cell of the flow cytometer, may also contribute to the decrease of sample carryover. Further, based on the conducted studies, if any amount of solvent was retained in the tubing, the sample probe or the flow cell of the flow cytometer, it did not appear to have an effect on the anti-adhesion benefits of the poly-HEMA.

After step 2, the conduit is coated and ready for sample acquisition. As shown in FIGS. 5A and 5B, the poly-HEMA coated tubing was reliably used for continuous sampling of a 96-well plate with drastically reduced cell carryover.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method for sample delivery, comprising:
obtaining a plurality of samples from a sample source having a plurality of wells, wherein each sample of the plurality of samples is obtained from a respective well of the plurality of wells;
moving the plurality of samples comprising particles into a fluid flow stream contained within a conduit having an inner diameter and in communication with a destination, wherein an inner surface of the conduit is coated with a hydrogel barrier substance; and
guiding the fluid flow stream through the conduit to the destination.

2. The method of claim 1, wherein the destination is an analyzer.

3. The method of claim 2, wherein:
the sample source comprises a plate having a plurality of sample wells;
the analyzer comprises a flow cytometer; and
the method further comprises: continuously operating the flow cytometer to focus the fluid flow stream and to analyze the particles in each of the plurality of samples as the fluid flow stream passes through the flow cytometer.

4. The method of claim 1, wherein the hydrogel barrier substance is biologically inert.

5. The method of claim 1, wherein the hydrogel barrier substance comprises Poly(2-hydroxyethyl methacrylate).

6. The method of claim 5, wherein the hydrogel barrier substance comprises a chemical derivative of Poly(2-hydroxyethyl methacrylate) selected from the group consisting of: polydimethylsiloxane, polymethyl methacrylate, polystyrene, and a polyethylene glycol diacrylate-based hydrogel.

7. The method of claim 1:
wherein adjacent samples of the plurality of samples are separated from each other in the fluid flow stream by a separation gas.

8. The method of claim 1, wherein the inner diameter of the conduit is between about 0.1 and about 10 mm.

9. The method of claim 1, wherein the conduit is formed of a plastic.

10. The method of claim 9, wherein the plastic is selected from the group consisting of: polyvinyl chloride (PVC), silicone, natural rubber, acidflex, polychlorotrifluoroethylene (PCTFE), polyethylene (PE), polypropylene, solvaflex, and Polytetrafluoroethylene (PTFE).

11. The method of claim 1, wherein the inner diameter of the conduit is about 0.25 millimeters.

12. A flow cytometry apparatus comprising:
an autosampler comprising a probe suitable for inserting a plurality of samples comprising particles from a plurality of respective source wells into a fluid flow stream;
a conduit having an inner diameter of between about 0.1 and 10 mm and connected to the probe of the autosampler and containing the fluid flow stream, wherein an inner surface of the conduit is coated with a hydrogel barrier substance; and
a flow cytometer in communication with the probe of the autosampler via the conduit, the flow cytometer configured to focus the fluid flow stream delivered by the conduit and analyze the particles in each of the plurality of samples.

13. The flow cytometry apparatus of claim 12, comprising a flow cell having an inner diameter of about 100-500 μm.

14. The flow cytometry apparatus of claim 12, wherein the hydrogel barrier substance is biologically inert.

15. The flow cytometry apparatus of claim 12, wherein the hydrogel barrier substance comprises Poly(2-hydroxyethyl methacrylate).

16. The flow cytometry apparatus of claim 12, wherein the conduit is formed of a plastic.

17. The flow cytometry apparatus of claim 16, wherein the plastic is selected from the group consisting of: polyvinyl chloride (PVC), silicone and natural rubber.

18. A method comprising:
preparing a Poly(2-hydroxyethyl methacrylate) (“poly-HEMA”) solution;
filling a conduit with the poly-HEMA solution;
incubating the conduit filled with the poly-HEMA solution at room temperature for an incubation period; and
after completion of the incubation period, priming the conduit with a buffer for a priming period.

19. The method of claim 18, wherein the incubation period is about 2-20 minutes.

20. The method of claim 18, wherein the priming period is about 1-10 minutes.

21. The method of claim 18, wherein the tubing is not cleaned prior to the filling step.

22. The method of claim 21, wherein the step of preparing the poly-HEMA solution of an anti-adhesion substance comprises:
adding an amount of poly-HEMA powder in about 50-100% ethanol to achieve about a 5-100 mg/ml poly-HEMA solution;
warming the poly-HEMA solution to about 20-80° C.;
agitating the poly-HEMA solution every hour for at least two hours;
incubating the poly-HEMA solution at about 20-80° C. for about 8-16 hours; and
agitating the poly-HEMA solus are visible in the solution.

23. The method of claim 18, wherein the conduit is fluidly connected to a flow cytometer and wherein the method further comprises the step of: after completion of the incubation period, passing the poly-HEMA solution and the buffer from the conduit through the flow cytometer to a waste receptacle.

24. The method of claim 23, wherein the flow cytometer comprises a flow cell having an inner diameter of about 100 μm to about 500 μm.
